(19) United States
(12) Patent Application Publication
(10) Pub. No.: US 2005/0074208 A1
(43) Pub. Date: Apr. 7, 2005

(54) Monitor for an optical fibre and multi-guide optical fibre circuits and methods of making them

(76) Inventors: Rodney Badcock, Slough (GB); Ian Peter Giles, Purley (GB); Shafig Parwaz, Moorpark (GB)

Correspondence Address: Lawrence G. Fridman, Esq.;SILBER & FRIDMAN, 66 Mount Prospect Avenue, Clifton, NJ, 07013, US

(21) Appl. No.: 10/810,345

(22) Filed: Mar. 26, 2004

Related U.S. Application Data
(63) Continuation of application No. PCT/GB02/04437, filed on Sep. 27, 2002.

(30) Foreign Application Priority Data
Sep. 28, 2001 (GB) GB 0123367.5
Oct. 22, 2001 (GB) GB 0125275.8

(51) Int. Cl. G02B 6/26

(52) U.S. Cl. 385/48; 385/30

(57) ABSTRACT

The invention relates to a monitor for monitoring at least one optical signal parameter in an opticl fibre having an access region of reduced cladding sufficient to allow access to the evanescent field. The monitor includes an optical element mountable adjacent to the access region of an optical fibre which optical element is capable of obtaining access to the evanescent field to enable use of the data therein to derive the at least one optical signal parameter.

### FIELD OF THE INVENTION

This invention relates to a monitor for an optical fibre for monitoring properties thereof.

### BACKGROUND OF THE INVENTION

The propagating wave in an optical fibre is contained within the Silica core and is guided along the fibre with very little loss. The primary requirement from the fibre is to transmit the light within to the required destination, with low loss and no interference from the outside environment, which may corrupt the information carried by the light. These qualities, which make the fibre an ideal transmission medium make the optical signal difficult to access from outside the fibre without either interrupting the light path or bending the fibre to allow light to escape, in both cases considerably enhancing the possibility of corrupting the signal. Both methods introduce high loss and potential mechanical reliability problems.

In many fibre applications it is desirable to establish whether there is light in the fibre and monitor some of its properties; such as polarisation state, wavelength, power or information being carried.

The optical signal in a fibre can, at present, be sampled from the fibre by:
1. Bending the fibre which encourages light to escape so that the escaped light can be detected and evaluated. However, this method is unsatisfactory since it induces losses and the escaping light is quite dispersed once it penetrates the cladding thickness
2. Tapping a small amount of power from the optical fibre using a directional coupler (power splitter) which diverts a small portion (<1%) of the light into another fibre This method suffers from the disadvantage that it induces losses equal to the level of power tapped and also losses due to the directional coupler itself.

In both of the above cases an optical detector is required to convert the optical parameter being measured to an electronic signal, e.g. power.

It will now be considered the way in which the light propagates within an optical fibre.

A portion of the field of the propagating wave extends into the cladding and rapidly decays exponentially through the cladding. This field is an integral part of the propagation and, if it can be accessed it allows the light wave parameters to be measured. In order to achieve this, it is necessary to remove at least the major part of the cladding at which the propagating wave is to be accessed. Two options are available, to remove cladding material until the field is reached or to extend the field beyond the fibre cladding. The cladding can be removed by either, grinding and polishing or etching with acid and the field can be extended whilst reducing the cladding by heating the fibre and tapering.

### SUMMARY OF THE INVENTION

Although all methods are feasible for the invention discussed here, the preferred approach is to grind and polish one side of the fibre which has advantages of providing a flat exposed side to access the field, and in that less material needs to be removed leaving a robust component. Also, better control of exposed length can be achieved and this method is suitable for high yield manufacture.

Using this known method, the fibre is ground to remove the appropriate amount of cladding material and then polished to provide a good quality optical surface.

In one method, as shown in FIG. 1, the fibre 1 comprising a core 3 in a cladding 5 is mounted in a substrate block 7 in an arc and ‘flat’ polished or polished over a rotating wheel. Alternatively the fibre 1 can be suspended over a polishing wheel to give a surface finish shown in FIG. 2. As can be seen, the fibre 1 has a length L of reduced outer cladding 5, the cladding over this length L having a residual cladding depth d.

The method used to produce the form shown schematically in FIG. 2, allows control of, the length of the exposed region, and the thickness of the remaining cladding.

The invention seeks to provide a monitor for monitoring the optical signal parameters in an optical fibre which enables low losses to be achieved, both induced and polarisation dependent and to provide access to the fibre without the use of additional fibre paths.

According to a first aspect of the invention there is provided a monitor as set out in accompanying claim 1.

According to a second aspect of the invention there is provided a monitor for monitoring the optical signal parameters in an optical fibre comprising a fibre having a region of reduced cladding sufficient to allow access to the evanescent field of the optical fibre and an optical element mounted adjacent to the said region of reduced cladding to obtain access to the evanescent field so as to enable use to be made of the data therein.

The optical fibres may be a single mode, multimode or polarisation maintaining fibre.

Preferably, the optical element is a photo detector arranged to access the evanescent field a produce an electrical signal related thereto.

Means may be provided for maintaining the photo detector and the access region in a fixed relationship which includes the photo detector being in contact with the access region of the fibre.

A lens may be interposed between the access region and the photo detector. Additionally or alternatively, a polariser or a wavelength filter may be interposed between the access region and the photo detector.

A plurality of photo detectors may be provided, each with a different polariser or wavelength filter for detecting different polarising fields or wavelengths.

An array of photo detectors may be provided with an array of elements provided between the detector array and the fibre, the elements being selected from one or more of polarisers and wavelength filters.

A plurality of fibres may be arranged in parallel and have aligned access areas and a photo detector array may span all of the access regions.

Alternatively, the optical element may comprise a second optical fibre, the end of which is located adjacent to the access region for capturing light output from the evanescent field and a lens may be interposed between the access region and the end of the second fibre.

According to a third aspect of the invention, there is provided a channel monitor for a multichannel optical fibre comprises means for splitting an input fibre into a plurality of fibres each having an aligned access regions and each carrying a single channel, an array of photo detectors spanning the access regions of the said plurality of fibres, and means for combining the plurality of fibres into a single output fibre.

The optical fibres may be a single mode, multimode or polarisation maintaining fibre.

According to a fourth aspect of the invention there is provided a control arrangement as set out in accompanying claim 23.

According to a fifth aspect of the invention, there is provided a control arrangement for controlling the power in an optical fibre comprises a monitor as above described, a variable optical attenuator upstream of the monitor and control means for controlling the attenuator including an input for setting the desired power and means for comparing the output from the monitor with the desired power input.

According to a sixth aspect of the invention, there is provided a control arrangement for providing constant optical attenuation in an optical fibre comprises a variable optical attenuator controlling the attenuation of the fibre, a first monitor as described above upstream of the attenuator, a second monitor as described above downstream of the attenuator and control means for controlling the attenuator including means for determining the attenuation in the fibre from the outputs of the two monitors an input for setting the desired attenuation and means for comparing the determined attenuation with the desired attenuation and controlling the attenuator accordingly.

This invention further relates to multi-guide optical fibre circuits.

In applications utilising fibre based systems it is necessary to direct portions of the signal and modify the signal propagation selectively, which demands optical components providing a specified functionality. The passive, benign nature of the optical fibre has produced solutions utilising alternative more optically active materials to provide this functionality. The solutions may be:
1. A traditional free space bulk option in which the light from an optical fibre is collimated, the desired function is applied externally to the fibre and the optical signal is re-focussed into one or more optical fibres.
2. An integrated optics solution in which a wave-guide is created in a more optically active or optically accessible material to provide functionality, the component wave-guide is then attached into the optical fibre transmission medium.

In both these options a component has to be attached into the optical fibre, thereby necessitating splitting of the fibre so that it can be connected on both sides of the component with the resulting performance and manufacturing precision penalties.

An alternative solution is to build the optical circuit onto an optical fibre. To accomplish this the evanescent field from the fibre which extends into the cladding surrounding the core must be accessed. This can be achieved by, extending the field beyond the cladding by tapering and thus thinning the cladding or by removing part of the cladding through etching or grinding and polishing. Although any method of accessing the field is appropriate for use in the present invention, the grinding and polishing method is preferred and will be used to describe the principles of the invention.

Grinding and polishing the fibre provides access to the evanescent field of the fibre whilst maintaining the integrity of the fibre; only one side of the cladding is removed. FIGS. 18 and 19 show schematically a polished optical fibre 1 having a core 3 and a cladding 5 in which the length L of the exposed or access region 7 can be adjusted as well as the thickness d of the remaining cladding.

This approach offers significant performance advantages over the alternative component manufacturing methods, for example:
i) The fibre is continuous so there are no in-line mismatches, reducing the insertion loss and any reflections.
ii) Mechanical connections between the fibre medium and the component medium are not required.
iii) The processing does not break the fibre so there are no problems with contamination of the in-line optical path.

The present invention seeks to provide an analogous system which enables this type of technique to a multi-fibre environment.

According to a seventh aspect of the invention, there is provided a multi-guide optical fibre circuit comprising a plurality of optical fibres having access regions formed therein for access to the evanescent field of the fibres, these regions being transversely aligned to form a substrate surface and an electro and/or optical circuit on the substrate surface with access to the evanescent field.

The surfaces of access regions may be optically flat and lie substantially in the same plane. The fibres may be mounted in a plurality of parallel grooves in a block of material, preferably silicon. The grooves may be V-shaped and etched into one surface of the block.

According to a eighth aspect of the invention, there is provided a method of making a multi-guide optical fibre circuit comprising forming an access region in each of a plurality of optical fibres, mounting the optical fibres in parallel with their access regions transversally aligned to provide a substrate surface and forming an electro and/or optical circuit thereon.

The surfaces of the access regions may be formed optically flat and the fibres may be mounted with the optical flats of the access regions lying in substantially the same plane.

The method may include producing a plurality of parallel grooves in one surface of a block of material and positioning he fibres individually in the grooves.

The block may be made of silicon and the method also includes etching a plurality of V-shaped grooved therein.

The circuit may be made on the substrate surface by applying masking to the substrate surface removing the masking from regions of the substrate to be exposed and forming electrodes or attaching optical devices to the exposed regions.

Areas on which electrodes are to be mounted may be exposed at a first time and the areas to which optical devices are to be attached may be exposed at a second time. The said first time may be later than said second time.

### BRIEF DESCRIPTION OF THE DRAWINGS

The invention will now be described in greater detail, by way of example, with reference to the drawings, in which.

FIG. 1 shows schematically the mounting of an optical fibre for polishing:

FIG. 2 shows schematically the result of a second method of optical fibre polishing:

FIG. 3 shows schematically a first embodiment of the invention;

FIG. 4a shows schematically one arrangement for the mounting of the photo detector of FIG. 3:

FIG. 4b shows schematically a second arrangement for mounting the photodetector of FIG. 3,

FIG. 5 shows schematically the use of a polariser with the photo-detector;

FIG. 6 shows schematically the use of two spaced photo detectors and polarisers;

FIG. 7a shows schematically the use of a wavelength filter with the photo detector;

FIG. 7b shows graphically the transmitted power and wavelength using the set up of FIG. 7a;

FIG. 8a shows schematically a set up using a number of photo detectors to measure different wavelength of transmitted power;

FIG. 8b is a graph similar to FIG. 7b showing the results of the use of the set up of FIG. 8a;

FIG. 9 shows the use of a multi-filter array;

FIG. 10 shows schematically an arrangement of a number of fibres mounted with their reduced cladding regions aligned;

FIG. 11 shows schematically the use of a detector array with the mounting arrangement shown in FIG. 10;

FIG. 12 shows schematically an arrangement for capturing light into a second fibre.

FIG. 13 shows schematically an arrangement for detecting the direction of propagation in a fibre;

FIG. 14 shows schematically an arrangement for controlling the power in an optical fibre;

FIG. 15 shows schematically an arrangement for maintenance of constant attenuation in a fibre;

FIG. 16 shows schematically an arrangement for monitoring individual channels in an optical fibre, and

FIG. 17 shows schematically an alternative arrangement for channel monitoring.

FIG. 18 is a schematic longitudinal sectional view of an optical fibre having a prepared access region;

FIG. 19 is a transverse section of the fibre shown in FIG. 18 in the access region thereof;

FIG. 20 is a plan view showing an arrangement of a number of parallel fibres mounted in a block to form a substrate;

FIG. 21 is a sectional view taken on the line IV-IV of FIG. 20,

FIG. 22 is a view illustrating the use of an optical flat to align the surfaces of the mounted fibres shown in FIGS. 20 and 21, and

FIG. 23 is an enlarged view of the area marked VI of FIG. 20 showing the mounting of circuit components thereon.

### DESCRIPTION OF THE PREFERRED EMBODIMENT

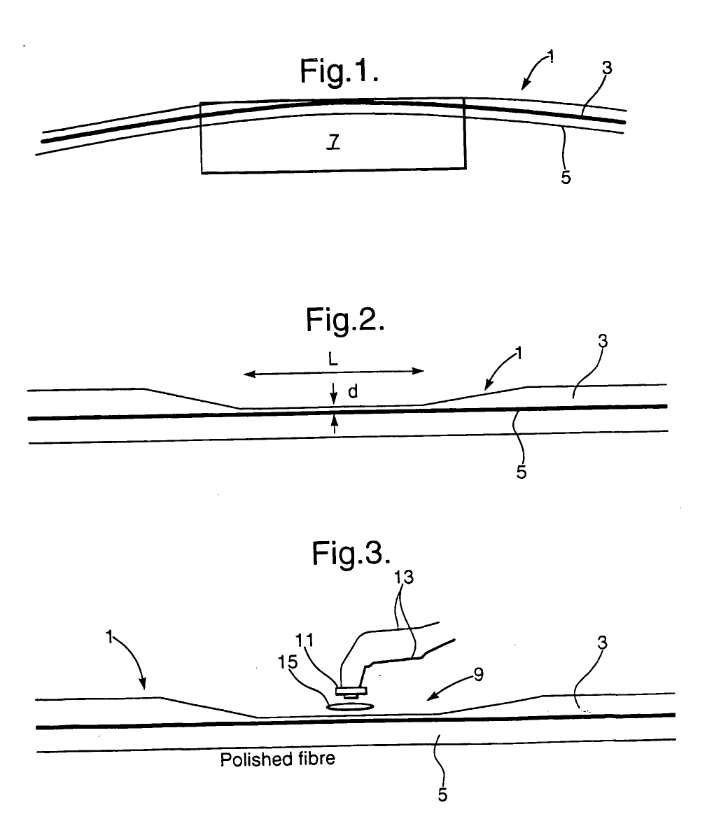

Referring firstly to FIG. 3, a first embodiment of the invention is shown. The figure shows an optical fibre 1 having a cladding 3 and core 5 with an access region 9 in which the cladding 3 is reduced by the method discussed above in relation to FIG. 2. An optical detector 11 provided with electronic output leads 13 is positioned adjacent to the optical fibre 1 in the region 9 so that it detects the evanescent field and converts this into an electrical signal on the leads 13. A lens 15 may be provided between the fibre 1 and the photo detector 11 if desired.

In practice, an holding mechanism (not shown) is used for holding the optical fibre with the exposed face vertical, such as a V-groove etched or machined into a suitable mounting material to hold the fibre firmly and allow it to be fixed permanently. The photo detector 11 is likewise mounted in the mounting material with its active area in close proximity to the exposed face of the access region 9 so as to mechanically hold it in a fixed position. The detector 11 is held vertically above the fibre 1 with its active surface parallel to the polished face or at an angle to the surface appropriate for the light in radiation modes escaping the fibre. The level of light reaching the detector 11 can be modified by altering the remaining cladding thickness or adjusting the distance between the fibre 1 and the detector 11. The lens 15, if used, is placed between the fibre surface and the detector to concentrate the light onto the detector active surface area. The whole assembly is packaged for mechanical rigidity.

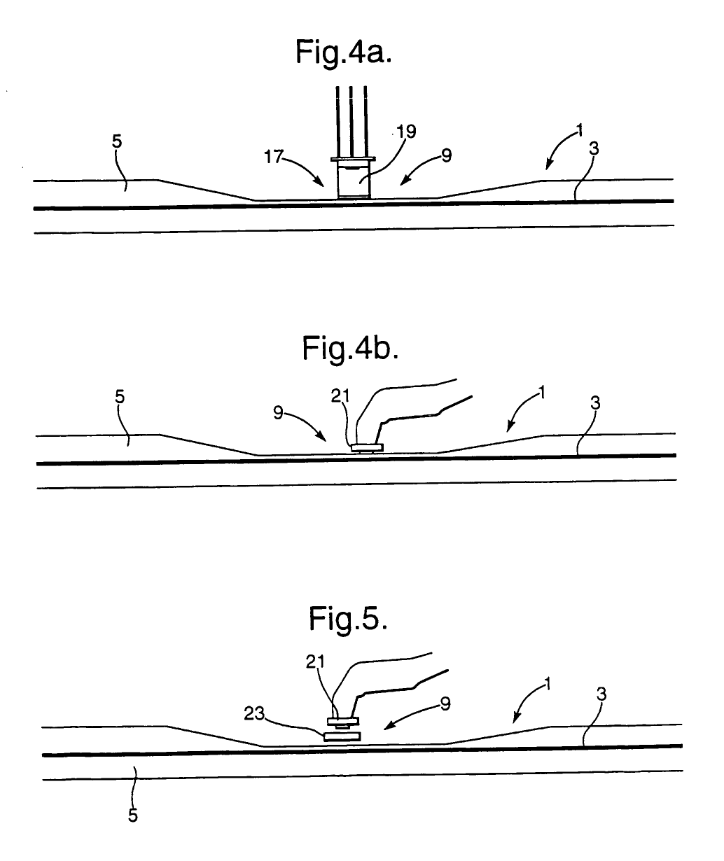

FIG. 4a shows an arrangement to fix the detector in the form of a package 17 directly positioned directly on the optical to the fibre surface in the access region 9. Thus the detector is pre-mounted in a housing 19 with a glass or lensed window and the access region of fibre 1 is fixed permanently to the window using for example an optical epoxy.

A more compact version of this arrangement is shown in FIG. 4b. Here a chip detector 21 is used without housing and fixed directly to the fibre 1 in the access region 9. For this embodiment the level of power (number of photons) reaching the detector active surface can be optimised by varying the remaining cladding thickness. The optimisation will ensure sufficient detected power with low insertion loss.

The evanescent field approach is generally applicable to all known optical fibre types and dielectric waveguides.

In the next embodiment of the invention (FIG. 5) information is detected in relation to a polarisation maintaining optical fibre in which two linear polarisation states are defined in the fibre.

The embodiments so far described have monitored optical power level, but other information about the light signal is often required. Placing an optical element between the access region of the fibre and the detector can select the specific characteristic sought.

FIG. 5 shows an aligned polariser 23 placed between the detector 21 and the access region 9 of the fibre. This will enable the power in a selected polarisation state to be monitored. This is particularly important for PM fibres in which the two polarisation states may have different power levels.

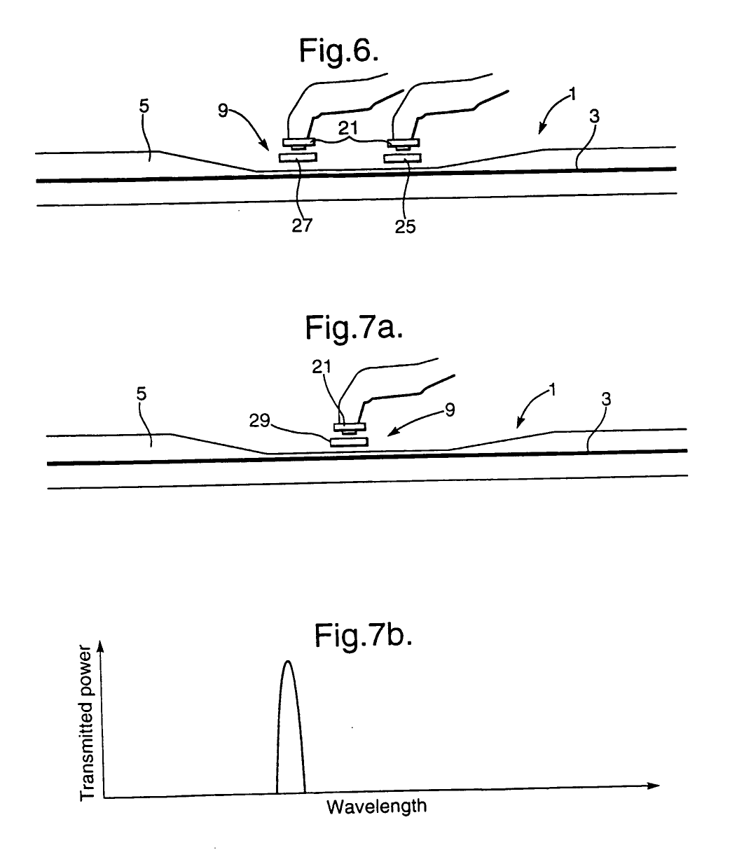

FIG. 6 shows an arrangement for detecting the power in two orthogonal polarisation states simultaneously. For this purpose, two detectors 21 are used and the polarising elements 25 and 27 between the two detectors 21 and the access region 9 are set at right angles relative to one another.

In a similar fashion, wavelength filters can be used to select a specific wavelength (FIG. 7a). Thus the arrangement is similar to that of FIG. 5 except that the polariser 23 is replaced with a wavelength filter 29. The filter 29 can be designed to filter specific Dense Wavelength Division Multiplexer (DWDM) channels in a communication network for example, to detect the power level or assess whether the channel is lit’. The filters can, as shown, be placed between fibre 1 and detector 21, formed on the surface of the access region 9 of the fibre 1 or formed on the surface of the detector 21. A typical output from the detector 21 is shown in FIG. 7b.

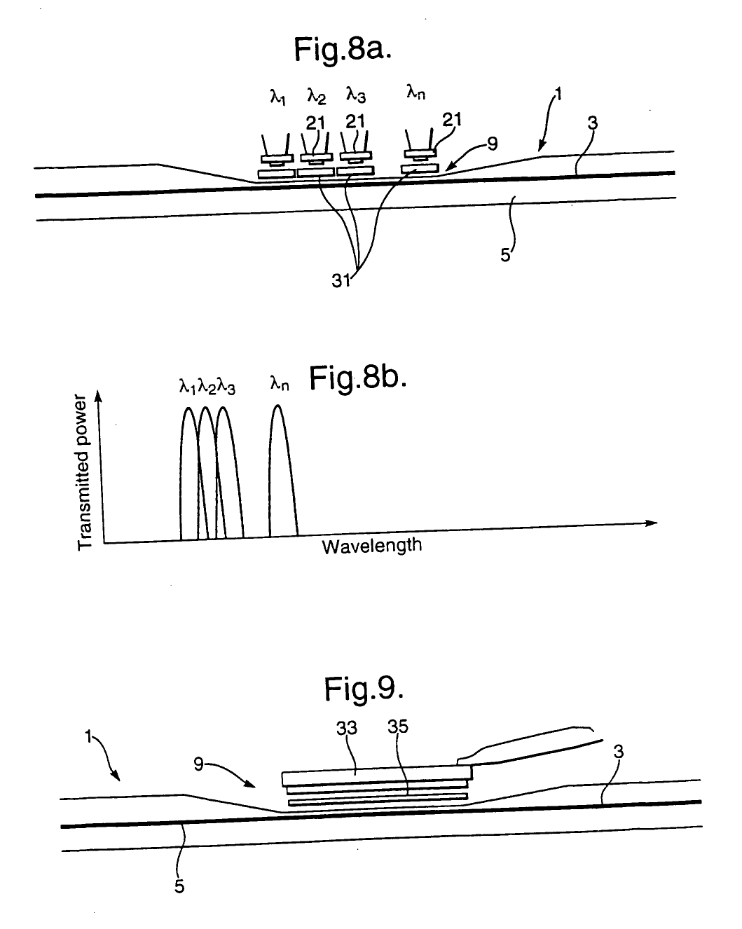

In the embodiment of FIG. 8a several detectors 21 are used with different wavelength selecting filters 31. These detectors 21 and their associated filters 31 are placed along the surface of the access region 9 to access a number of channels at once. FIG. 8b shows the type of output which can be obtained from such a detector system.

In an alternative embodiment shown in FIG. 9, a linear detector array 33 is used together with a series of discrete filters or a graded filter 35. Several of these devices can be cascaded to cover the full channel range for a network.

Multi-channel communication systems demand multiple components in a package. All of the previously discussed embodiments can be adapted for use in multi-fibre environment.

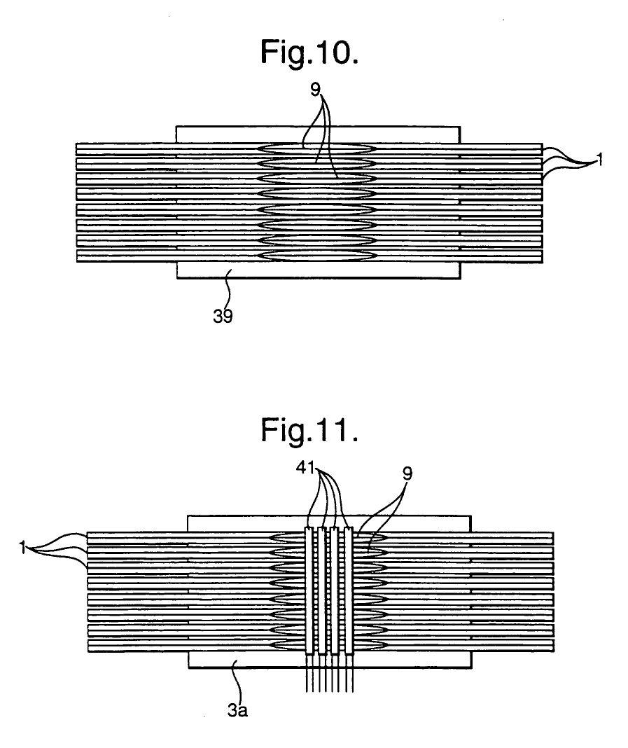

FIG. 10 shows a way in which a number of optical fibres 1 can be positioned in parallel. If these fibres 1 have been treated to reduce the cladding thickness at certain points to produce access areas 9 then the fibres can be placed in a carrier 39 and held with their access regions 9 transversely aligned. Then several linear arrays 41 (FIG. 11) or a single two dimensional array could be used across all or, in any event, several fibres. In this case, the power in each fibre is detected by addressing the appropriate detector element. Several such arrays used together enable multi-channel versions of the other components to be realised.

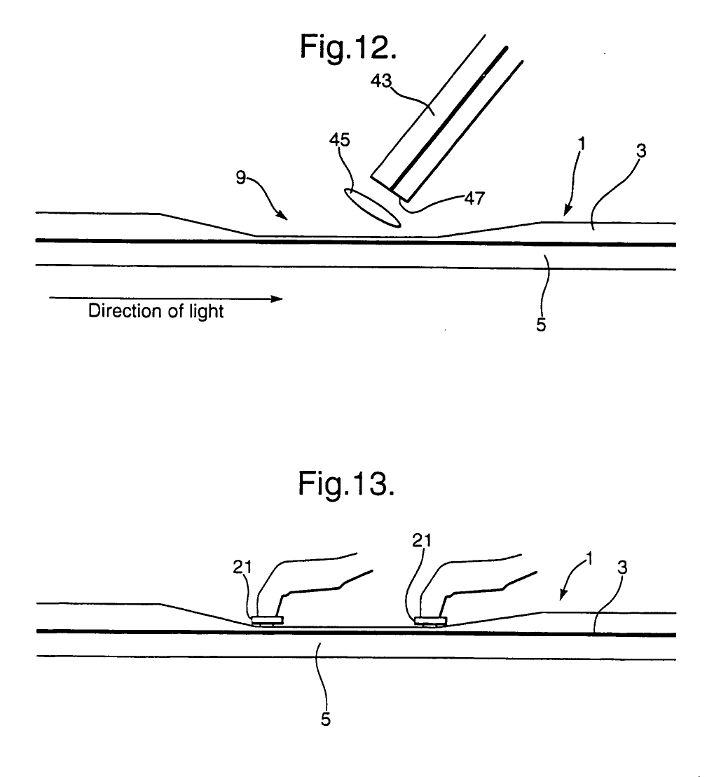

For remote detection, as shown in FIG. 12, an additional fibre 43 can be placed in close proximity to the exposed surface of the access region 9 to guide a portion of the light to a detector (not shown). A lens 45 at or on the fibre end 47 will enhance the level of power launched into the sampling fibre 43.

In some applications, directionality along the fibre of the optical signal is important. This can be detected using the arrangement shown in FIG. 13. The relative power level detected by detectors is a function of the angle between the detector and the fibre with a maximum when the detector is angled to match the exit angle of the light. Two detectors 21 placed optimally for each direction enable the levels of power transmitted in each direction to be detected and thus the directionality determined.

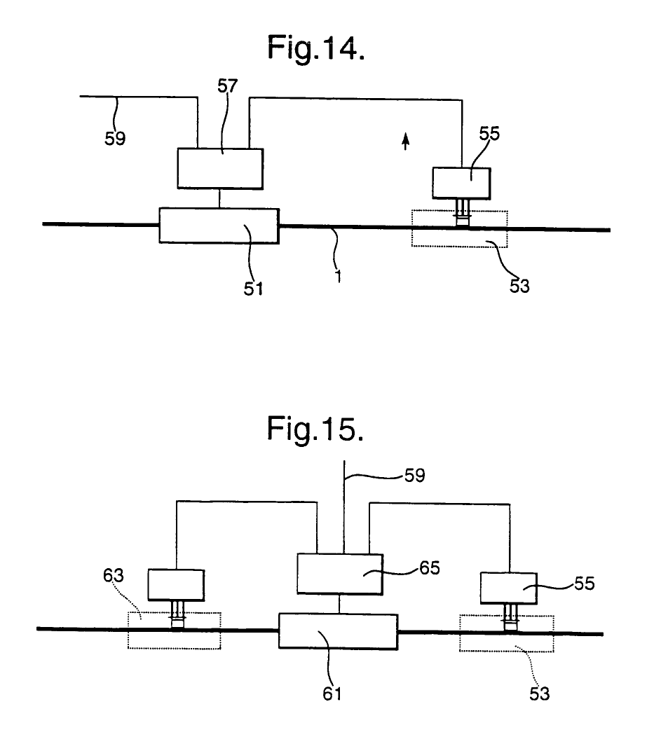

FIG. 14 shows an application of the invention used for power control by control of a power level controlling variable optical attenuator 51. The power level in the optical fibre 1 after the attenuator 51, is detected by a photo detector 53, constructed in accordance with any suitable preceding embodiment. An electronic conditioning circuit 55 gives an output voltage proportional to the sampled power level. The voltage is compared in a control circuit 57 to a set voltage level provided by input 59 and an error signal generated. The error signal controls the attenuator 51 to maintain the power level detected by the monitor 53 and consequently the power level in the fibre 1.

Similarly, for example, the power from a laser can be controlled by feedback to the laser power control circuitry.

FIG. 15 shows the use of an attenuator 61 to provide a fixed attenuation. In this case the circuit is similar to that of FIG. 14 but with an additional detector 63 on the other side of the attenuator 61 to the detector 53. Here, the control circuit 65 generates an error signal to control the attenuator 61 which is derived by taking the ratio of the two detected voltages and comparing it with the input set voltage on the input line 59.

Placed in a fibre the detector will produce an output current when there is light in the fibre and no current when light is absent. This provides a low loss method of checking for signals in fibre lines.

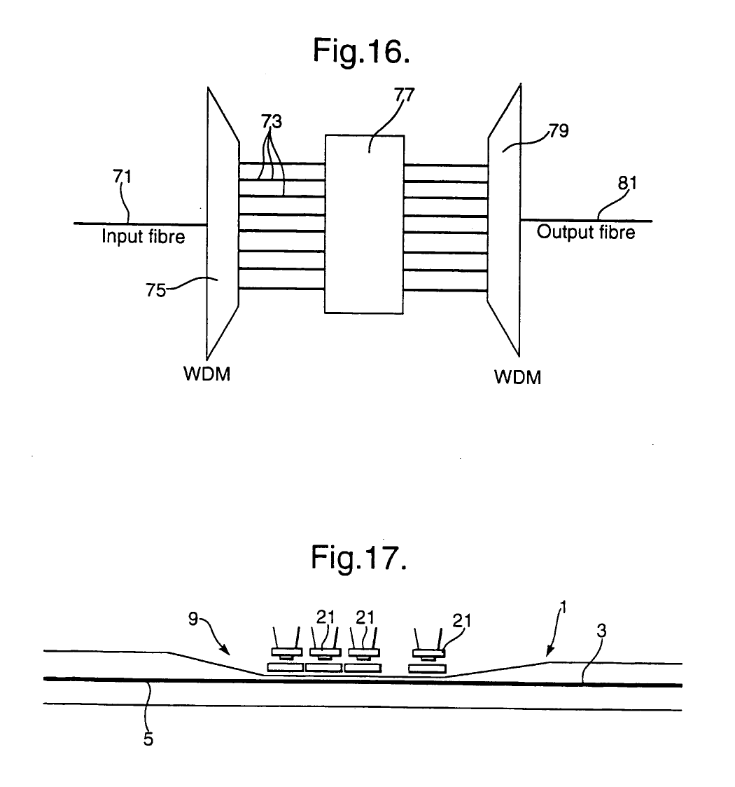

FIG. 16 shows a channel monitor in which the optical channels carried by a single fibre 71 in a DWDM network are split into individual channels in individual fibres 73 through a Wavelength Division Multiplexer (WDM) 75 and the relative power levels of each channel can be monitored and adjusted if necessary using an attenuator. Individual detectors or a detector array 77 can be used. The channels are then recombined by a second WDM 79 into a single output fibre 81.

FIG. 17 shows an alternative channel monitor in which no splitting of the fibre is required. A single fibre 1 is used and a line of detectors 21 are used, each of the detectors having different filtering characteristics along the access region of the fibre surface.

It will be appreciated that the above described monitors can have many other applications, including, for example, spectral analysis.

In the seventh and eighth aspects of the invention, optical fibres form the basic substrate on which a circuit can be constructed. The key to integration is to create a substrate of multiple fibres on to which precision optical circuits can be built utilising conventional electronic and optical integrated component manufacturing techniques.

Initial fibre processing provides a flat exposed surface close to the optical fibre core within the extent of the evanescent field.

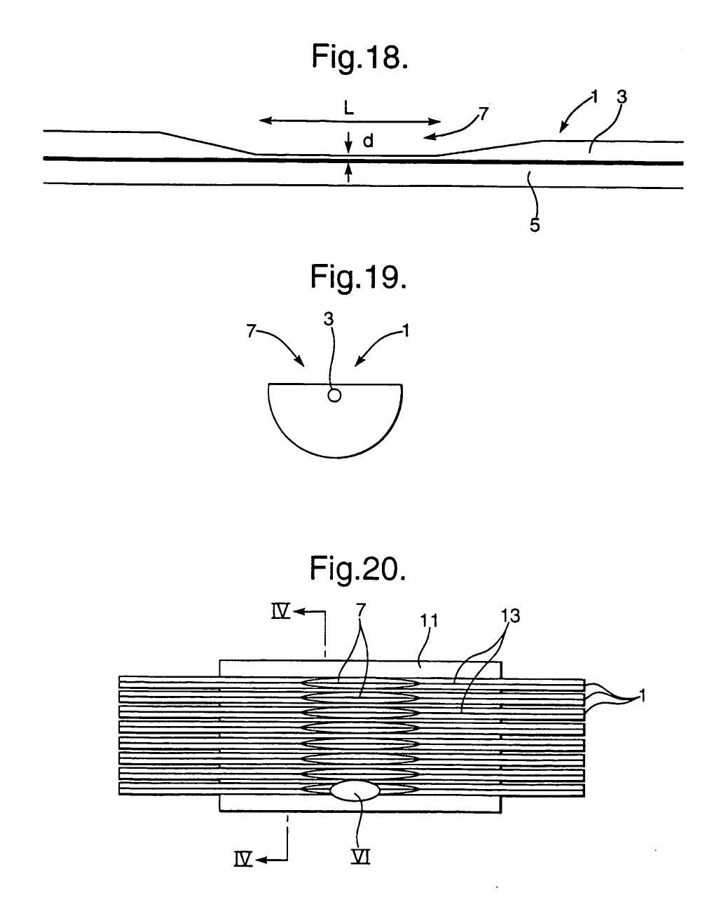

This can be achieved by the use of the ground and polished fibre of FIGS. 18 and 19 or alternatively a D-type fibre (which has the same section as FIG. 19 but along its whole length). The latter has the disadvantage of non-circular cross section to connect to the conventional fibre transmission medium.

Any suitable type of fibre can be processed by this method to provide the basic element of the integration. In particular polarisation maintaining (PM) optical fibres can be aligned such that the axes lie perpendicular and parallel to the exposed surface.

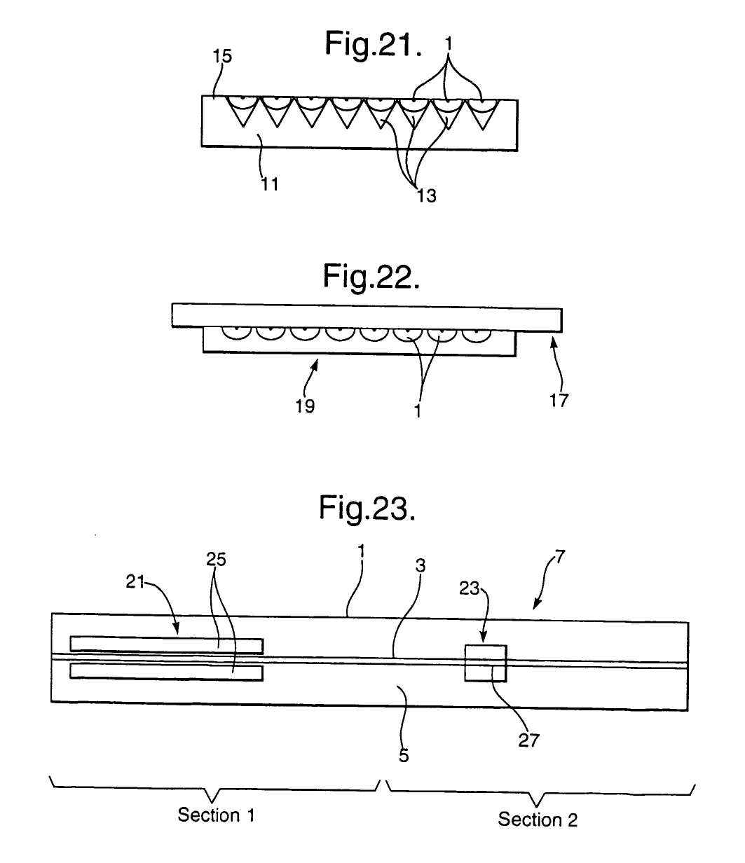

The principle of the invention can be carried out to provide a multi channel substrate on to which electro- and/or optical components and circuits can be built using the following steps:
a) A series of optical fibres corresponding to the number of channels required are processed, as described in relation to FIGS. 18 and 19 to access the evanescent field of the fibres.
b) The fibres are accurately positioned relative to one another, side by side and parallel to each other with their access regions transversely aligned.
c) This fibre ‘pack’ is fixed to a base to create a multi-fibre substrate which is shown in FIGS. 20 and 21.

To provide such a fixing, a block 11 of a suitable material has grooves 13 machined in parallel along its length to receive the fibres 1. This block comprises the base. The shape of the grooves 13, as shown, are V-sectioned but they may alternatively be semi-circular or rectangular. They are machined to such a depth that the processed fibre 1 is slightly above the surface 15 of the block 11 (FIG. 21) and the length of the grooves 13 (and thus the block 11) extends beyond the access regions 7 of the fibres 1. The fibres 1 are fixed into the grooves 13 with appropriate adhesive systems or glass or metal solders or by fusion.

The material of the base 111 should be such that the grooves 13 can be accurately machined and can in principle be any material, metals, glass, quartz, polymers. In practice physical characteristics such as thermal expansion coefficients compared to the silica fibre are important.

One of the preferred solutions is V-grooves etched into silicon, which is a standard process and produces accurately positioned and dimensioned grooves.

The optical flats of the access regions 7 of the fibres 1 can be aligned in parallel by using an optically flat reference plate. Once the fibres 1 are positioned in the grooves 13, the flat is placed on the fibres 1 and manipulated until all surfaces of the access regions 7 of fibres 1 align with the face of the flat so as to form a flat surface. The fibres 1 are fixed in this position.

In an alternative (FIG. 22) the fibres 1 are attached with a dissolvable adhesive to an optical flat 17, the fibres 1 being placed such that they touch each other. They are potted with an appropriate compound 19 in this position. When the potting compound has been cured, the optical flat can be removed by dissolving the adhesive leaving the completed substrate.

Substrates formed in either of these ways can be processed utilising conventional electronic and optical circuit processing techniques, such as; photolithographic techniques, laser writing, evaporation, and material growing techniques.

Once supported in a base substrate of this type mask alignment techniques facilitate the development of multi-functionality along the fibre interaction length. That is, one part of the access region can be protected whilst another part is being processed by, for example, evaporating materials in a certain order and then the said one part can be protected whilst the another section undergoes the required processing.

This concept enables a circuit to be built onto the fibre substrate.

One example of such a multi element circuit comprises is a variable attenuator 21 (Section 1) with a power tap 23 (Section 2) as shown in FIG. 23. To produce this multi element circuit, firstly photolithographic techniques or similar are used to define a region in section 1 for receiving electrodes of the attenuator 21 whilst masking the rest of the interaction region and, in particular, section 2. Then electrodes are evaporated onto the exposed access region 7 of fibre 1. A material to provide the correct variation of refractive index with temperature is coated over appropriate parts (e.g. 25) of section 1 whilst section 2 remains protected.

Section 2 is then cleaned and a photodiode 27, forming the tap 23, is fixed in place.

Electrical connections are made to the electrodes by wire bonding.

Such a device provides variable attenuation for the transmitted light and direct detection of the output power level in the fibre to provide a power control feedback.

In addition to the multi-function capability of the of the above described embodiment, many multi-channel devices can be realised, in compact format. For example a 32 fibre unit could be realised in a substrate of 10 mm by 5 mm.

It will be appreciated that the invention can be applied to any conventional fibre type.

Of particular importance is the polarisation maintaining optical fibre which has defined preferential linear polarisation axes along its length. The use of the above described substrate approach with PM fibres facilitates the arrangement of polarisation control components.

1. A monitor for monitoring at least one optical signal parameter in an optical fibre having an access region of reduced cladding sufficient to allow access to the evanescent field, the monitor comprising an optical element mountable adjacent to the access region of an optical fibre which optical element is capable of obtaining access to the evanescent field to enable use of the data therein to derive the at least one optical parameter.

2. A monitor for monitoring the optical signal parameters in an optical fibre comprising a fibre having an access region of reduced cladding sufficient to allow access to the evanescent field of the optical fibre and an optical element mounted adjacent to the access region to obtain access to the evanescent field so as to enable use to be made of the data therein.

3. A monitor as claimed in claim 1, wherein the fibre is a single made fibre.

4. A monitor as claimed in claim 1, wherein the fibre is a multimode fibre.

5. A monitor as claimed in claim 1, wherein the fibre is a polarisation maintaining fibre.

6. A monitor as claimed in claim 1, wherein the optical element is a photo detector arranged to access the evanescent field and produce an electrical signal related thereto.

7. A monitor as claimed in claim 6, wherein means are provided for maintaining the photo detector and the access region in a fixed relationship.

8. A monitor as claimed in claim 6, wherein the photo detector is in contact with the access region of the fibre.

9. A monitor as claimed in claim 6, wherein a lens is interposed between the access region and the photo detector.

10. A monitor as claimed in claim 7, wherein a polariser is interposed between the access region and the photo detector.

11. A monitor as claimed in claim 10, wherein a plurality of photo detectors are provided, each with a different polariser for detecting different polarising fields.

12. A monitor as claimed in claim 7, wherein a wavelength filter is interposed between the access region and the photo detector.

13. A monitor as claimed in claim 11, wherein a plurality of photo detectors are provided, each with a different wavelength filter for detecting different wavelengths.

14. A monitor as claimed in claim 6, wherein an array of photo detectors are provided with an array of elements between the detector array and the fibre, the elements being selected from one or more of the polarisers and wavelenght filters.

15. A monitor as claimed in claim 1, wherein a plurality of fibres are arranged in parallel and have aligned access areas and a photo detector array spans all of the access regions.

16. A monitor as claimed in claim 1, wherein the optical element comprises a second optical fibre, one end of which is located adjacent to the access region for capturing light output from the evanescent field.

17. A monitor as claimed in claim 16, wherein a lens is interposed between the access region and the end of the second fibre.

18. A channel monitor for a multi-channel optical fibre, comprising means for splitting an input fibre into a plurality of fibres each having mutually aligned access regions and each carrying a smaller number of channels than the multi-channel fibre, an array of photo detectors spanning the access regions of the said plurality of fibres, and means for combining the plurality of fibres into a single output fibre.

19. A monitor according to claim 18, wherein the multi-channel fibre is a single mode fibre.

20. A monitor according to claim 18, wherein the multi-channel fibre is a multimode fibre.

21. A monitor according to claim 18, wherein the multi-channel fibre is a polarisation maintaining fibre.

22. A monitor as claimed in claim 18, wherein each of the plurality of fibres carries a single channel.

23. A monitor as claimed in claim 1, wherein said monitor forming a part of a control arrangement for controlling a signal in an optical fibre, said control arrangement further including a controller responsive to the at least one optical signal parameter to alter at least one parameter of the signal.

24. A monitor as claimed in claim 23, wherein the monitor is arranged before the controller when viewed in the direction of the passage of an optical signal.

25. A monitor as claimed in claim 23, wherein the monitor is arranged after the controller when viewed in the direction of the passage of an optical signal to provide closed-loop control.

26. A monitor as claimed in claim 23, wherein the controller is arranged to alter at least the power of the signal.

27. A monitor as claimed in claim 1, wherein said monitor forms a part of a control arrangement for controlling the power in an optical fibre, said control arrangement further including a variable optical attenuator upstream of the monitor and control means for controlling the attenuator including an input for setting the desired power and means for comparing the output from the monitor with the desired power input.

28. A monitor as claimed in claim 1, wherein said monitor forms a part of a control arrangement for providing constant optical attenuation in an optical fibre comprising a variable optical attenuator controlling the attenuation of the fibre, said monitor arranged upstream of the attenuator, a second monitor arranged downstream of the attenuator and control means for controlling the attenuator including means for determining the attenuation in the fibre from the outputs of the two monitors, an input for setting the desired attenuation and means for comparing the determined attenuation with the desired attenuation and controlling the attenuator accordingly.

29. A multi-guide fibre circuit, comprising a plurality of optical fibres having access regions formed therein for access to the evanescent field of the fibres, these regions being transversely aligned to form a substrate surface and an electro- and/or optical circuit on the substrate surface with access to the evanescent field.

30. A circuit as claimed in claim 29, wherein the surfaces of access regions are optically flat and lie substantially in the same plane.

31. A circuit as claimed in claim 29, wherein the fibres are mounted in a plurality of parallel grooves in a block of material.

32. A circuit as claimed in claim 31, wherein the block is silicon and the grooves are V-shaped and etched into one of the block.

33. A circuit as claimed in claim 29, wherein the electro- and/or optical circuit comprises a variable attenuator and a tap.

34. A method of making a multi-guide optical fibre circuit, comprising forming an access region in each of a plurality of optical fibres, mounting the optical fibres in parallel with the access regions transversely aligned to provide a substrate surface and forming an electro- and/or optical circuit thereon.

35. A method according to claim 34, wherein the surfaces of the access regions are formed optically flat and the fibres are mounted with the optical flats of the access regions lying in substantially the same plane.

36. A method according to claim 34, wherein the method includes producing a plurality of parallel grooves in one surface of a block of material and positioning the fibres individually in the grooves.

37. A method according to claim 36, wherein the block is made of silicon and the method also includes etching a plurality of V-shaped grooves therein.

38. A method according to claim 34, wherein the circuit is made on the substrate surface by applying masking to the substrate surface removing the masking from regions of the substrate to be exposed and forming electrodes or attaching optical devices to the exposed regions.

39. A method according the claim 38, wherein areas on which electrodes are to be mounted are exposed at a first time and the areas to which optical devices are to be attached are exposed at a second time.

40. A method according to claim 39, wherein the said first time is later than said second time.

41. A method according to claim 39, wherein the electrodes are the electrodes of a variable attenuator and the optical device is a tap.
